(19) United States
(12) Patent Application Publication
(10) Pub. No.: US 2014/0212001 A1
(43) Pub. Date: Jul. 31, 2014

(54) Visual odometry

(71) Applicant: Quantum Signal LLC, Saline, MI (US)

(72) Inventors: Victor E. Perlin, Ann Arbor, MI (US); David B. Johnson, Ann Arbor, MI (US)

(21) Appl. No.: 13/947,520

(22) Filed: Jul. 22, 2013

Related U.S. Application Data
(63) Continuation of application No. 13/751,138, filed on Jan. 27, 2013, now abandoned.

(51) Int. Cl. G06T 7/20

(52) U.S. Cl. CPC G06T 7/20
USPC 382/107

(57) ABSTRACT

Visual odometry is achieved via various approaches.

### RELATED APPLICATIONS

The present patent application claims priority to the previously filed and presently pending patent application filed on Feb. 21, 2013, and assigned patent application Ser. No. 13/751,138, which claims priority to the previously filed and now abandoned patent application filed on Jun. 17, 2012, and assigned patent application Ser. No. 13/525,343, which claims priority to the provisional patent application, now abandoned, filed on Jun. 18, 2011, and assigned patent application No. 61/498,543.

### BACKGROUND

Visual odometry is the process of estimating or measuring the motion of a vehicle through analysis of image sequences collected by a camera mounted on or of the vehicle.

### DETAILED DESCRIPTION

Visual odometry is achieved via the approaches described in the provisional patent application noted above, the entire contents of which are hereby incorporated by reference.

We claim:

1. A visual odometry approach.

2. A system and method for visual odometry.
